(19) United States
(12) Patent Application Publication
(10) Pub. No.: US 2004/0010482 A1
(43) Pub. Date: Jan. 15, 2004

(54) Creation theory

(76) Inventor: James R. Austin, McAllen, TX (US)

Correspondence Address: James R. Austin, 609 Heron Ave, McAllen, TX, 78504-2047, US

(21) Appl. No.: 10/194,357

(22) Filed: Jul. 11, 2002

(51) Int. Cl. G06F 17/00; G06N 5/00; G06F 7/00

(52) U.S. Cl. 706/45; 707/102

(57) ABSTRACT

This invention provides the Creation Theory. The Creation Theory is a method of creating things that represent other things, especially those that are part of a variable/amorphous structure.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX:

Not Applicable

### BACKGROUND OF THE INVENTION

This invention provides the Creation Theory. The Creation Theory is a method of creating things to represent other things, especially those that are part of a variable/amorphous structure.

In the US Patent System, this invention can be classified under the subclass Mathematics (932) under the class Data Processing—AI (706).

The term theory is used in the mathematical context meaning a body of definitions, axioms, theorems, or the like, belonging to one subject (i.e. Set Theory or Number Theory).

This invention resulted from searching for a better solution to the difficulties encountered in representing, processing and evolving variable/amorphous data structures.

After years of failure to find the ideal solution using databases, a decision was made to start afresh.

The past 18 months of research and development pinpointed the solution as the thing used to represent other things and yielded the invention of the Creation Theory.

Consider the word “pen” (a thing) that represents a thing that is long and cylindrical and leaves a permanent mark on paper.

Consider the letter “p” (a thing) that represents one of the alphabets in the English language.

Consider the number “0” (a thing) that represents no thing.

What method was used to create “pen”, “p” and “0”?

The Creation Theory is a method of creating things (similar to “pen”, “p” and “0”) to represent other things, especially those that are part of a variable/amorphous structure.

### BRIEF SUMMARY OF THE INVENTION

This invention provides the Creation Theory. The Creation Theory is a method of creating things that represent other things, especially those that are part of a variable/amorphous structure.

### BRIEF DESCRIPTION OF THE SEVERAL VIEWS OF THE DRAWING

Not Applicable

### DETAILED DESCRIPTION OF THE INVENTION

This invention provides the Creation Theory. The Creation Theory is a method of creating things that represent other things, especially those that are part of a variable/amorphous structure.

Axiom 1:

Things can be used to represent other things.

Axiom 2:

A thing (also referred to as “it”) is a set. The set contains two subsets. One subset contains references to thing(s), if any, that created “it”. The other subset contains references to thing(s), if any, that “it” created. The total number of references within “it” is variable from zero (0) to a positive integer whose maximum value is limited by resources available in the system where “it” is implemented.

Notations:

Let letter(s) and/or number(s) (i.e. x, k1) note a thing.

Let “=” note equivalence of things on either side of it.

Let “{ }” note a set.

Let “,” separate things, including sets.

Let “->” note a reference to the thing following it.

Let “ . . . ” note that the prior pattern may continue.

Axiom 2 (Restated Using Above Notation):

x={{->k1, ->k2, . . . }, {->c1, ->c2, . . . }}

where the first subset notes the thing(s), if any, that created “it”;

the second subset notes the thing(s), if any, that “it” created;

and the total number of references is limited by system resources.

Terminology:

To facilitate communication of a thing, the following terminology is used:

A thing can be referred to as a creator, creature or sibling with respect to another thing.

For example, suppose we have things k1, k2, x, c1, c2

where k1 and k2 create x;

and x creates c1 and c2.

In this scenario, we say thing x is a creature of things k1 and k2.

We say, thing x is the creator of things c1 and c2.

We say, things c1 and c2 are siblings since they have the same creator(s).

In other words: Creators, creatures and siblings are all things.

Axiom 2 (Restated Using Above Terminology):

A thing (“it”) is a set. The set contains two subsets. One subset contains references to creator(s), if any. The other subset contains references to creature(s), if any. The total number of references within “it” is variable from zero (0) to a positive integer whose maximum value is limited by resources available in the system where “it” is implemented.

Axiom 2 (Restated Using Above Terminology and Notation):

x={{->creator1, ->creator2, . . . }, {->creature1, ->creature2, . . . }}

where either or both subsets can be empty;

and the total number of references is limited by system resources.

Destruction Theorem:

A thing cannot be destroyed if other thing(s) reference(s) it.

Basic Operations (op.):

Op1) A thing can recall it's creator(s), if any.

Op2) A new thing can be created given a set of creator(s), if any:

Op2a) Allocate system resources for the new thing.

Op2b) Instruct the new thing to store reference(s) to its creator(s), if any.

Op2c) Instruct creator(s), if any, to store a reference to the new thing as its/thier creature.

Op3) A thing can recall its creature(s), if any.

Exercise of Things and Operations:

Let “-rk->” note the operation of a thing recalling its creator(s), if any.

Let “-ct->” note the operation of creating a new thing based on creator(s), if any.

Let “-rc->” note the operation of a thing recalling its creature(s), if any.

1. (start with no thing in a system)

2. -ct->x (create x, it has no creator(s) within its system)

3. x-ct->x1 (x creates x1)

4. x-ct->x2 (x creates x2)

5. x-ct->x3 (x creates x3 and so on)

Therefore we say:

Thing x creates things x1, x2, x3, . . . .

Noted as: {x}-ct->{x1, x2, x3, . . . }

Thing x is the creator (“of x1, x2, x3, . . . ” implied).

Noted as: Creator(s)={x}.

x1, x2, x3, . . . are creatures (“of x” implied).

Noted as: Creature(s)={x1, x2, x3, . . . }

Creator(s) can recall its/their creature(s), if any.

Noted as: {x}-rc->{x1, x2, x3, . . . }

Creature(s) can recall its/their creator(s), if any.

Noted as: {x1, x2, x3, . . . }-rk->{x}

Now we create more things:

6. {x1, x2}-ct->x12a

7. {x1, x2}-ct->x12b

Therefore we note:

{x1, x2}-ct->{x12a, x12b, . . . }

Creator(s)={x1, x2}

Creature(s)={x12a, x12b, . . . }

{x1, x2}-rc->{x12a, x12b, . . . }

{x12a, x12b, . . . }-rk->{x1, x2}

Now we create more things:

7. {x1, x2, x3}-ct->x123a

8. {x1, x2, x3}-ct->x123b

Therefore we note:

{x1, x2, x3}-ct->{x123a, x123b, . . . }

Creator(s)={x1, x2, x3}

Creature(s)={x123a, x123b, . . . }

{x1, x2, x3}-rc->{x123a, x123b, . . . }

{x123a, x123b, . . . }-rk->{x1, x2, x3}

The above process of creating things can be extended until the implementing system's resources are exhausted.

The best use of the Creation Theory is to create things to build databases, programs and operating systems.

Currently, the most practical mode contemplated by the inventor for carrying out the invention is on programmable computers.

In the future, practical modes may include mechanically, biologically and optically programmable systems.

Although implementation of the Creation Theory is not limited to computers, it is demonstrated below using the standard C programming language on a Personal Computer system for the purpose of clarity.

```
Start of file thing.c********************
/************************************************************
// Creation Theory implemented on IBM-Compatible PC using C.
Thing Structure
Creator1
Creator2
. . .
CreatorX
NULL
Creature1
Creature2
. . .
CreatureX
NULL
Variable abbreviations:
p = pointer
pc = constant pointer
************************************************************/
// To facilitate comprehension of thing,
// implementation has been simplified
// by limiting each to having no more than 100 creators and creatures total.
// Optimal implementation requires
  dynamic memory allocation & error handlers.
  const int kmMaxCreatorsAndCreaturesInThing = 100;
  const int kmNullsInThing = 2;
/************************************************************
(Op1) Returns a NULL terminated list
with reference(s) to thing's creator(s), if any.
************************************************************/
const int*const Thing_RecallCreators (const int*const pcThing)
{
return (pcThing);
}
/************************************************************
(Op2c) Stores the provided single reference (pCreature)
as a creature of thing (pcThing).
************************************************************/
void Thing_StoreCreature
(const int* const pcThing, const int* const pCreature)
{
int* pThing = (int*)pcThing;
// Var for counting creators and creatures
int q = 0;
//Skip creator(s)
while (*pThing) {
++q;
++pThing;
}
//Skip terminating NULL
++pThing;
//Skip to last creature
while (*pThing) {
++q;
++pThing;
}
// Limit total creators and creatures
if (q >= kmMaxCreatorsAndCreaturesInThing + kmNullsInThing)
return;
// Store creature
*pThing = (int)pCreature;
// Add terminating NULL
++pThing;
*pThing = NULL;
}
/************************************************************
(Op2) Creates new thing based on creator(s),
if any, specified in NULL terminated list.
************************************************************/
const int*const Thing_Create (const int* const pcCreator)
// Calc system resources for new thing.
int q = 0;
int* pCreator = (int*)pcCreator;
while (pCreator && *pCreator) {
++q;
++pCreator;
}
// Error checking
if (q >= kmMaxCreatorsAndCreaturesInThing)
return (NULL);
// (Op2a) Allocate system resources for new thing
const int*const pcThing
= (int*)malloc ((kmMaxCreatorsAndCreaturesInThing +
kmNullsInThing) * sizeof(int));
// (Op2b) Instruct new thing to memorize its creator(s), if any.
pCreator = (int*)pcCreator;
int* pThing = (int*)pcThing;
while (pCreator && *pCreator) {
*pThing = *pCreator;
++pCreator;
++pThing;
}
// Terminate new thing's list of creator(s)
*pThing = NULL;
// Init new thing's creature list
++pThing;
*pThing = NULL;
// (Op2c) Instruct creator(s), if any,
// to memorize new thing as its/their creature.
pCreator = (int*)pcCreator;
while (pCreator && *pCreator) {
Thing_StoreCreature ((int*) *pCreator, pcThing);
++pCreator;
}
return (pcThing);
}
/************************************************************
(Op3) Returns a NULL terminated list
with reference(s) to thing's creature(s), if any.
************************************************************/
const int* const Thing_RecallCreatures (const int* const pcThing)
{
int* pThing = (int*)pcThing;
//Skip creator(s)
while (*pThing) {
++pThing;
// Skip terminating NULL
++pThing;
return (pThing);
}
/************************************************************
// Demo Creation Theory by creating things that represent abstract things.
************************************************************/
void CreationTheory_Demo1(void)
{
// Delcare array to store upto 100 creators and 1 terminating NULL.
// This array is loaded prior to calling Thing_Create.
// It should be loaded with creators of new Thing.
int* pCreator[kmMaxCreatorsAndCreaturesInThing + 1];
// Create x
  const int*x = Thing_Create (NULL);
//Create x1 based on creator x
  pCreator[0] = (int*)x;
  pCreator[1] = NULL;
  const int* x1 = Thing_Create ((int*)pCreator);
//Create x2 based on creator x
  pCreator[0] = (int*)x;
  pCreator[1] = NULL;
  const int x2 = Thing_Create ((int*)pCreator);
// Create x3 based on creator x
  pCreator[0] = (int*)x;
  pCreator[1] = NULL;
  const int* x3 = Thing_Create ((int*)pCreator);
// Create x12a based on creators x1 and x2
  pCreator[0] = (int*)x1;
  pCreator[1] = (int*)x2;
  pCreator[2] = NULL;
  const int* x12a = Thing_Create ((int*)pCreator);
//Create x12b based on creators x1 and x2
  pCreator[0] = (int*)x1;
  pCreator[1] (int*)x2;
  pCreator[2] = NULL;
  const int* x12b = Thing_Create ((int*)pCreator);
// Create x123a based on creators x1, x2 and x3
  pCreator[0] = (int*)x1;
  pCreator[1] = (int*)x2;
  pCreator[2] = (int*)x3;
  pCreator[3] = NULL;
const int* x123a = Thing_Create ((int*)pCreator);
// Create x123b based on creators x1, x2 and x3
  pCreator[0] = (int*)x1;
  pCreator[1] = (int*)x2;
  pCreator[2] = (int*)x3;
  pCreator[3] = NULL;
  const int* x123b = Thing_Create ((int*)pCreator);
}
/************************************************************
// Demo Creation Theory by creating things that represent concrete things.
************************************************************/
void CreationTheory_Demo2 (void)
// Delcare array to store upto 100 creators and 1 terminating NULL.
// This array is loaded prior to calling Thing_Create.
// It should be loaded with creators of new Thing.
int*pCreator[kmMaxCreatorsAndCreaturesInThing + 1];
// Create unit of measure (uom)
  const int* uom = Thing_Create (NULL);
// Create uom/1b
  pCreator[0] = (int*)uom;
  pCreator[1] = NULL;
  const int*1b = Thing_Create ((int*)pCreator);
// Create property
  const int* property = Thing_Create (NULL);
// Create property/weight
  pCreator[0] = (int*)property;
  pCreator[1] = NULL;
  const int* weight = Thing_Create ((int*)pCreator);
// Create value
  const int*value = Thing_Create (NULL);
// Create value/100
  pCreator[0] = (int*)value;
  pCreator[1] = NULL;
  const int* v100 = Thing_Create ((int*)pCreator);
// Create time
  const int* time = Thing_Create (NULL);
// Create time/t1
  pCreator[0] = (int*)time;
  pCreator[1] = NULL;
  const int* t1 = Thing_Create ((int*)pCreator);
// Create earth at t1
  pCreator[0] = (int*)t1;
  pCreator[1] = NULL;
  const int* earth = Thing_Create ((int*)pCreator);
// Create time/t2
  pCreator[0] = (int*)time;
  pCreator[1] = NULL;
  const int* t2 = Thing_Create ((int*)pCreator);
// Create adam on earth at t2
  pCreator[0] = (int*)earth;
  pCreator[1] = (int*)t2;
  pCreator[2] = NULL;
  const int* adam = Thing_Create ((int*)pCreator);
// Create time/t3
  pCreator[0] = (int*)time;
  pCreator[1] = NULL;
  const int* t3 = Thing_Create ((int*)pCreator);
// Create eve from adam at t3
// and set her weight to 100 lbs.
  pCreator[0] = (int*)adam;
  pCreator[1] = (int*)t3;
  pCreator[2] = (int*)weight;
  pCreator[3] = (int*)v100;
  pCreator[4] = (int*)1b;
  pCreator[5] = NULL;
  const int*eve = Thing_Create ((int*)pCreator);
// Verity one of eve's creator is adam
  bool adamIsACreator_b = false;
  int* pEvesCreators = (int*)Thing_RecallCreators(eve);
  while (*pEvesCreators) {
    if (*pEvesCreators == (int)adam) {
    adamIsACreator_b = true;
    break;
  }
  ++pEvesCreators;
}
// Verify one of adam's creatures is eve
  bool eveIsACreature_b = false;
  int* pAdamsCreatures = (int*) Thing_RecallCreatures(adam);
  while (*pAdamsCreatures) {
    if (*pAdamsCreatures == (int)eve) {
    eveIsACreature_b = true;
    break;
  }
  ++pAdamsCreatures;
  }
}
End of file******************************
```

1. I claim the Creation Theory.

2. I claim the things created by the Creation Theory.
